(19) United States
(12) Patent Application Publication
(10) Pub. No.: US 2016/0202102 A1
(43) Pub. Date: Jul. 14, 2016

(54) Construction Machine

(71) Applicant: Caterpillar SARL, Geneva (CH)

(72) Inventor: Masaru Mishima, Tokyo (JP)

(73) Assignee: Caterpillar SARL, Geneva (CH)

(21) Appl. No.: 14/988,431

(22) Filed: Jan. 5, 2016

(30) Foreign Application Priority Data
Jan. 8, 2015 (JP) 2015-002164

(51) Int. Cl. G01F 23/00; B60Q 9/00

(52) U.S. Cl. CPC G01F 23/00; B60Q 9/00

(57) ABSTRACT

This invention relates to a construction machine in which an operator can easily confirm that DEF level in a DEF tank has exceeded a predetermined level, when supplying DEF. With reference to FIG. 1, the construction machine comprises a DEF tank for storing DEF, a DEF level sensor for detecting DEF level in the DEF tank, warning means which warns to the operator and a controller which is connected to the DEF level sensor and the warning means. When DEF in the DEF tank exceeds a predetermined level which is detected by the DEF level sensor, the controller actuates the warning means. The warning means comprises at least one light e.g. a boom light or/and a horn.

### TECHNICAL FIELD

The present invention relates to a construction machine including a urea water tank that stores urea water serving as a reducing agent of nitrogen oxide.

### BACKGROUND ART

In vehicles such as construction vehicles, buses and trucks, a diesel engine is often used as a driving source. A lot of nitrogen oxide (NOx) and the like are included in exhaust gas of the diesel engine, and most of vehicles mounted with diesel engines are therefore subjected to emission control. Therefore, concerning the vehicles mounted with the diesel engines, it is requested to reduce a nitrogen oxide amount in the exhaust gas.

As a technique for reducing the nitrogen oxide amount in the exhaust gas, a urea SCR (Selective Catalytic Reduction) system is known. The urea SCR system causes a reduction reaction of nitrogen oxide in exhaust gas and urea water to thereby reduce a nitrogen oxide amount in the exhaust gas. The urea water serving as a reducing agent is stored in a urea water tank mounted on a vehicle, sucked by a urea water suction pump, and ejected from ejecting means, which is connected to an exhaust passage of an engine, into the exhaust passage.

Supply of the urea water to the urea water tank is performed using a urea water supply machine having a water supply stop function, a general-purpose container, or the like. When the water supply is performed using the urea water supply machine, the water supply is stopped by the water supply stop function of the urea water supply machine when a urea water amount in the urea water tank exceeds a predetermined amount. On the other hand, in a place where the urea water supply machine is not set such as a construction site, when the water supply is performed using the general-purpose container or the like, an operator needs to stop the water supply by himself or herself when the urea water amount in the urea water tank exceeds the predetermined amount. Therefore, on the outside of the urea water tank, in order to enable the operator to visually check the urea water amount in the urea water tank, a tubular gauge communicating with the inside of the urea water tank is sometimes disposed (see, for example, PTL 1).

### SUMMARY OF INVENTION

However, since a required amount of the urea water is small compared with fuel, usually, the urea water tank is formed smaller than a fuel tank. Therefore, it is sometimes difficult to visually recognize the gauge depending on a disposition place of the urea water tank in the vehicle. In this case, it is likely that the operator cannot confirm that the urea water amount in the urea water tank exceeds the predetermined amount and allows the urea water to overflow from the urea water tank.

The present invention has been devised in view of the above-mentioned fact and a main technical problem of the present invention is to provide a construction machine with which, irrespective of a disposition place of an urea water tank, an operator can easily confirm that a urea water amount in the urea water tank exceeds a predetermined amount when the operator is supplying urea water to the urea water tank.

According to the present invention, as a construction machine that solves the technical problem, there is provided a construction machine including: a urea water tank that stores urea water; detecting means for detecting a urea water amount in the urea water tank; warning means for issuing a warning to an operator who supplies the urea water to the urea water tank; and a controller connected to the detecting means and the warning means. The controller actuates the warning means when the detecting means detects that the urea water amount in the urea water tank exceeds a predetermined amount.

Preferably, the warning means is constituted by light emitting means. The controller suitably lights the light emitting means when the detecting means detects that the urea water amount in the urea water tank exceeds the predetermined amount. The controller favorably flashes the light emitting means when the detecting means detects that the urea water amount in the urea water tank is increasing. Preferably, the warning means is constituted by warning sound means for emitting a warning sound. The controller suitably continuously sounds the warning sound means when the detecting means detects that the urea water amount in the urea water tank exceeds the predetermined amount. The controller favorably intermittently sounds the warning sound means when the detecting means detects that the urea water amount in the urea water tank is increasing. Preferably, the warning means is constituted by light emitting means and warning sound means for emitting a warning sound. The controller suitably flashes the light emitting means when the detecting means detects that the urea water amount in the urea water tank is increasing, and sounds the warning sound means when the detecting means detects that the urea water amount in the urea water tank exceeds the predetermined amount. The controller favorably intermittently sounds the warning sound means when the detecting means detects that the urea water amount in the urea water tank is increasing, and lights or flashes the light emitting means when the detecting means detects that the urea water amount in the urea water tank exceeds the predetermined amount. The controller preferably changes a flashing interval of the light emitting means according to the urea water amount in the urea water tank detected by the detecting means. The controller suitably changes a sounding interval of the warning sound means according to the urea water amount in the urea water tank detected by the detecting means.

In the construction machine provided by the present invention, the controller actuates the warning means when the detecting means detects that the urea water amount in the urea water tank exceeds the predetermined amount. Therefore, according to the warning from the warning means, the operator can easily confirm that the urea water amount in the urea water tank exceeds the predetermined amount when the operator is supplying the urea water to the urea water tank.

### BRIEF DESCRIPTION OF DRAWINGS

FIG. 1 is a side view of a hydraulic excavator configured according to the present invention.

FIG. 2 is a perspective view of an upper slewing body shown in FIG. 1.

FIG. 3 is a perspective view of the inside of a cab shown in FIG. 1 and FIG. 2.

FIG. 4 is a diagram showing a configuration example of the hydraulic excavator shown in FIG. 1.

FIG. 5 is an electric circuit diagram showing connection of a controller, a horn, and a horn switch.

### DETAILED DESCRIPTION

First and second embodiments of a construction machine configured according to the present invention are explained in detail below with reference to the accompanying drawings citing a hydraulic excavator, which is a representative construction machine, as an example.

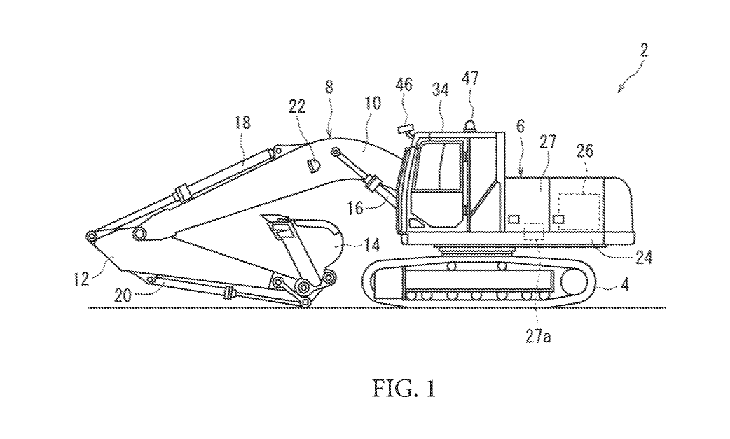

First, the first embodiment of the construction machine according to the present invention is explained. Referring to FIG. 1, the hydraulic excavator indicated by reference numeral 2 as a whole is roughly constituted by a lower traveling body 4 capable of self-traveling, an upper slewing body 6 mounted on the lower traveling body 4 so as to be able to slew, and a work arm apparatus 8 pivotably connected to the upper slewing body 6. During digging work of earth and sand and the like, the work arm apparatus 8 is pivoted and the upper slewing body 6 is slewed with respect to the lower traveling body 4, whereby the hydraulic excavator 2 can perform the digging work of the earth and sand and the like.

The work arm apparatus 8 is roughly constituted by a boom 10 pivotably connected to the front side of the upper slewing body 6, an arm 12 swingably connected to the distal end side of the boom 10, a work tool 14 turnably connected to the distal end side of the arm 12, a pair of boom cylinders 16 (only the left side is shown) that pivots the boom 10, an arm cylinder 18 that swings the arm 12, and a work tool cylinder 20 that turns the work tool 14. A boom work lamp 22 that illuminates an area ahead of the hydraulic excavator 2 is disposed in a side surface center portion of the boom 10.

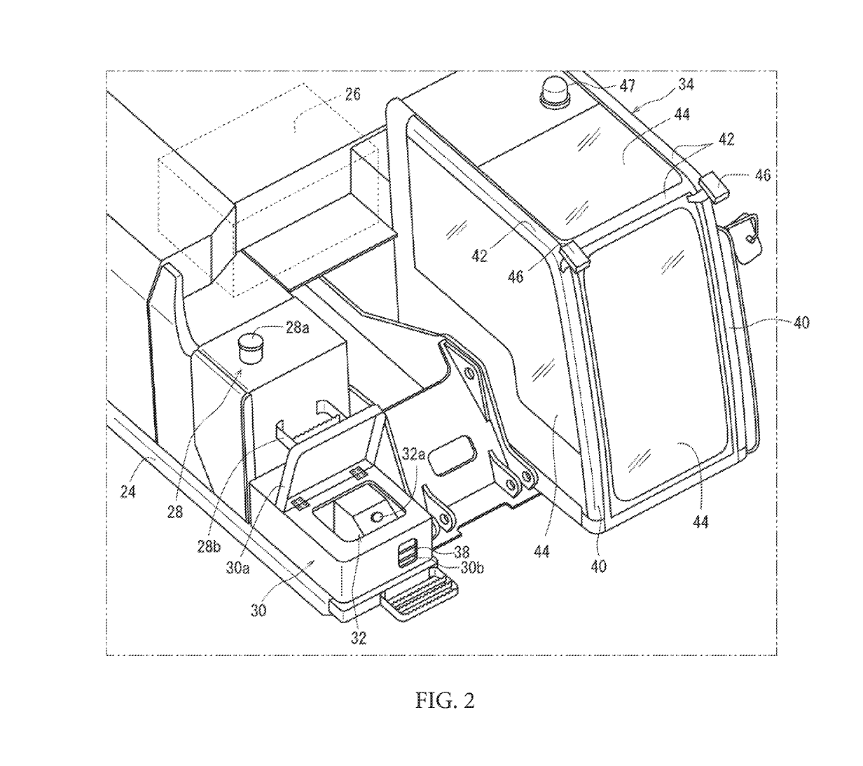

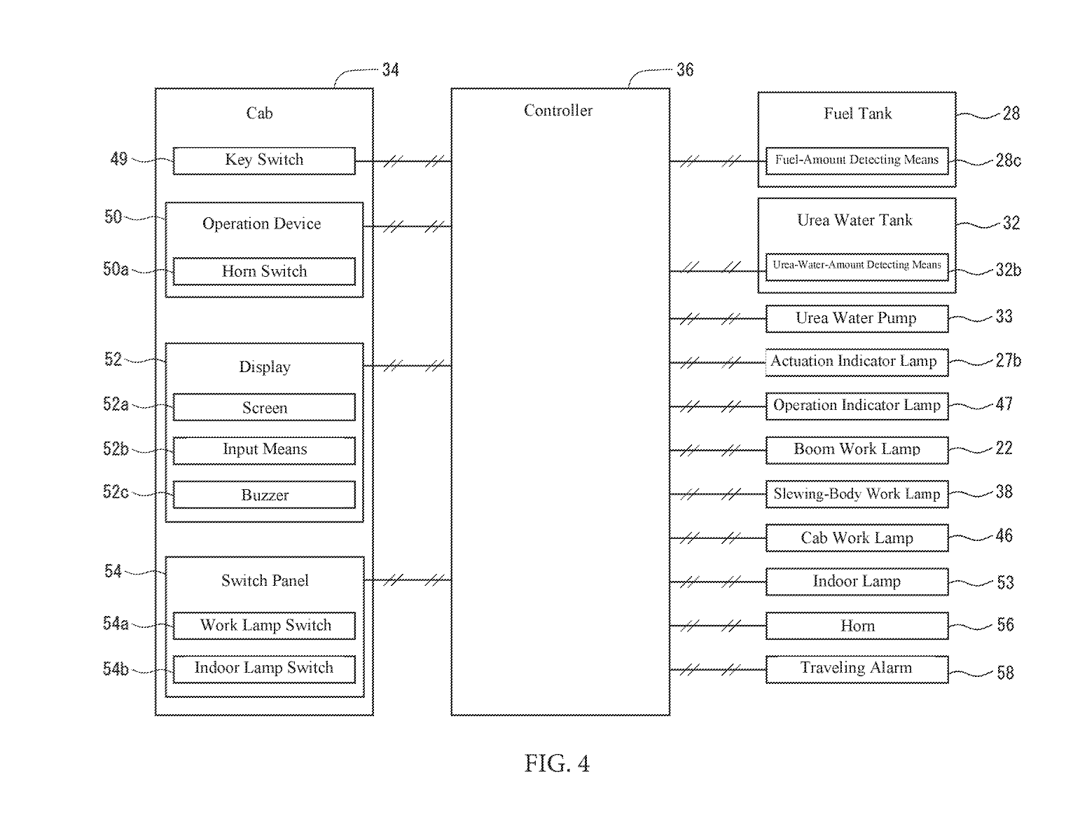

The hydraulic excavator 2 is explained with reference to FIG. 2 together with FIG. 1. The upper slewing body 6 includes a slewing frame 24 that forms a framework structure. In the slewing frame 24, a diesel engine 26 forming a driving source, a storage-battery housing chamber 27, a fuel tank 28 that stores fuel, a tool box 30 in which apparatuses necessary for actuation of the hydraulic excavator 2, or tools and the like used for maintenance are housed, a urea water tank 32 that stores urea water, a cab 34 on which a driver rides, a controller 36 (see FIG. 4) and the like are disposed.

In the storage-battery housing chamber 27, a storage battery 27a, a shutoff switch (not shown in the figure), an actuation indicator lamp 27b (see FIG. 4), and the like are disposed. The shutoff switch is a switch for shutting off power supply when inspection or the like of the hydraulic excavator 2 is performed. When the shutoff switch is off, power supply from the storage battery 27a to the apparatuses is shut off. On the other hand, when the shutoff switch is on, the power supply from the storage battery 27a to the apparatuses is allowed. However, even when the shutoff switch is off and when a key switch 49 explained below is off, in a predetermined case, some apparatuses receive the supply of electric power from the storage battery 27a and operate. Therefore, the working of such apparatuses is indicated by lighting of the actuation indicator lamp 27b.

The fuel tank 28 is formed in a rectangular parallelepiped shape as a whole from an appropriate steel material and disposed on the right front side of the slewing frame 24. A fuel filler port 28a is disposed on the upper surface of the fuel tank 28. A step 28b serving as a foot rest when the operator steps up to the upper slewing body 6 for inspection and maintenance is joined to a height-direction middle portion of the front surface of the fuel tank 28. Fuel-amount detecting means 28c (see FIG. 4) for detecting a fuel amount is disposed in the fuel tank 28. The fuel-amount detecting means 28c is constituted by a level sensor or the like.

The tool box 30 is formed in a rectangular parallelepiped shape as a whole from an appropriate steel material and smaller than the fuel tank 28 in a dimension in the up-down direction and disposed in front of the fuel tank 28. The upper surface of the tool box 30 is in a lower position than the step 28b of the fuel tank 28 and formed as a lid section 30a serving as a foot rest of the operator like the step 28b of the fuel tank 28 and capable of opening and closing via a hinge. An opening 30b is formed on the front surface of the tool box 30. A slewing-body work lamp 38 that illuminates the area ahead of the hydraulic excavator 2 is housed in the tool box 30 to face the opening 30b.

The urea water tank 32 is formed in a rectangular parallelepiped shape as a whole from an appropriate resin material or a steel material having relatively high corrosion resistance, for example, stainless steel and smaller than the fuel tank 28 and the tool box 30 and housed in the tool box 30. The upper surface of the urea water tank 32 includes a horizontal surface extending substantially horizontally and an inclining surface inclining downward and extending forward from the horizontal surface. A water supply port 32a is disposed on the inclining surface. Urea-water-amount detecting means 32b (see FIG. 4) for detecting a urea water amount is disposed in the urea water tank 32. The urea-water-amount detecting means 32b is constituted by a level sensor or the like. The urea water tank 32 is connected to a urea water pump 33 (see FIG. 4). The urea water in the urea water tank 32 is sucked by the urea water pump 33 and ejected from ejecting means (not shown in the figure), which is connected to an exhaust passage of the engine 26, into the exhaust passage. Note that, even when the shutoff switch is off and when the key switch 49 explained below is off, the urea water pump 33 sometimes receive power supply from the storage battery 27a and operates.

The cab 34 is formed in a frame structure from a plurality of columns 40 formed from a steel pipe and a plurality of beams 42 formed from a steel pipe and coupling the plurality of columns 40, covered with a window 44 and the like on a peripheral side surface, and disposed on the left front side of the slewing frame 24. A pair of left and right cab work lamps 46 that illuminates the area ahead of the hydraulic excavator 2 is disposed in a front surface upper portion of the cab 34. An operation indicator lamp 47 indicating that the hydraulic excavator 2 is operating is disposed in an upper surface rear portion of the cab 34. Note that the front-back direction and the left-right direction used in the explanation of this specification are the front-back direction and the left-right direction viewed from the driver riding on the cab 34 shown in FIG. 1 and FIG. 2.

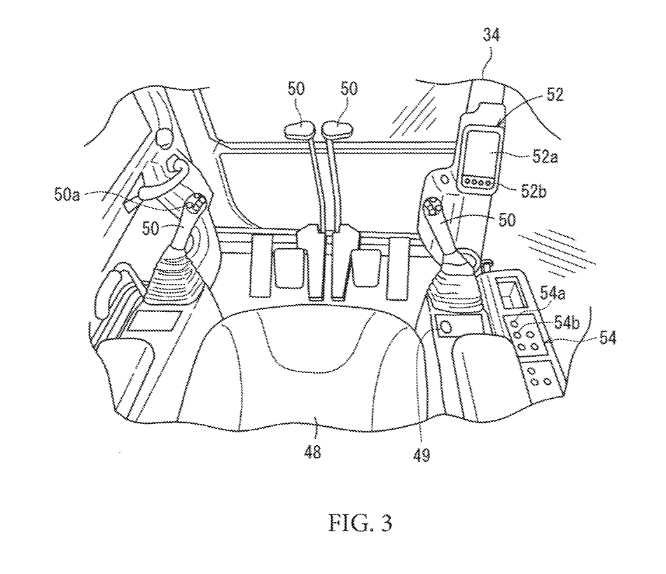

The cab 34 is explained with reference to FIG. 3. In the cab 34, a seat 48 on which the driver is seated, a key switch 49 that performs operation and stop of the engine 26 and allows and shuts off the power supply from the storage battery 27a to the apparatuses, a plurality of operation devices 50 that output signals for actuating a hydraulic actuator such as the boom cylinders 16, a display 52 that displays machine information and the like necessary for the driver, an indoor lamp 53 (see FIG. 4) that illuminates the inside of the cab 34, a switch panel 54 on which at least one switch is disposed, and the like are disposed. The key switch 49 can be configured form, for example, a well-known mechanical switch. When the key switch 49 is off, the engine 26 stops and the power supply from the storage battery 27a to the apparatuses is shut off. When the key switch 49 is turned from OFF to ON, the power supply from the storage battery 27a to the apparatuses is allowed. When the key switch 49 is further turned from ON to start, the engine 26 is actuated. A horn switch 50a that outputs a signal for sounding a horn 56 (see FIG. 4) is disposed on the upper surface of one of the operation devices 50, that is, in this embodiment, the operation device 50 located on the left side of the seat 48. The horn 56 emits a warning sound to the periphery of the hydraulic excavator 2. The horn 56 is used to, for example, call attention of other operators present around the hydraulic excavator 2, for example, when the operator starts the engine 26. When the operation devices 50, for example, a pair of operation devices 50 located in front of the seat 48 is operated, a signal for causing the hydraulic excavator 2 to travel by the lower traveling body 4 is output and a signal for sounding a traveling alarm 58 (see FIG. 4) is output. The traveling alarm 58 emits a warning sound to the periphery of the hydraulic excavator 2. The traveling alarm 58 is used to notify the other operators present around the hydraulic excavator 2 that the hydraulic excavator 2 is traveling.

A screen 52a is disposed in the display 52, in a position where the screen 52a can be visually recognized from the driver seated on the seat 48. Machine information images and the like of a fuel amount in the fuel tank 28, a urea water amount in the urea water tank 32, and the like are displayed on the screen 52a. A plurality of input means 52b are disposed below the screen 52a in the display 52. An image displayed on the screen 52a changes according to an input from the input means 52b and changes according to a signal or the like from the controller 36 as well. Further, in the display 52, a buzzer 52c (see FIG. 4) that emits a warning sound is incorporated. The buzzer 52c is used to notify the driver that, for example, various apparatuses are in abnormal states and replacement time of a predetermined component has passed. On the switch panel 54, a work lamp switch 54a for outputting signals for lighting or extinguishing the boom work lamp 22, the slewing-body work lamp 38, and the cab work lamps 46, an indoor lamp switch 54b that outputs a signal for lighting or extinguishing the indoor lamp 53, and the like are disposed. Note that the input means 52b, the work lamp switch 54a, and the indoor lamp switch 54b are constituted by a switch of a push button type in this embodiment. However, the input means 52b, the work lamp switch 54a, and the indoor lamp switch 54b may be a dial type, a seesaw type, a touch panel type, or a combination of these types. The buzzer 52c may be disposed in an appropriate place in the cab 34 rather than in the display 52.

The hydraulic excavator 2 is explained with reference to FIG. 4. The controller 36 is an electronic control device provided as an LSI device or an integrated electronic device in which a microprocessor, a ROM, a RAM, and the like, which are publicly known, are integrated. The controller 36 is disposed in an appropriate position of the upper slewing body 6. The controller 36 is electrically connected to the key switch 49, the operation devices 50, the display 52, and the switch panel 54 disposed in the cab 34 and is electrically connected to the fuel-amount detecting means 28c, the urea-water-amount detecting means 32b, the urea water pump 33, the actuation indicator lamp 27b, the operation indicator lamp 47, the boom work lamp 22, the slewing-body work lamp 38, the cab work lamps 46, the indoor lamp 53, the horn 56, the traveling alarm 58, and the like.

When the key switch 49 is operated to actuate the engine 26, the controller 36 lights the operation indicator lamp 47. When detecting that the urea water pump 33 is working, the controller 36 lights the actuation indicator lamp 27b. When signals for lighting or extinguishing the work lamps 22, 38, and 46 are output from the work lamp switch 54a, the controller 36 lights or extinguishes the work lamps 22, 38, and 46. When a signal for lighting or extinguishing the indoor lamp 53 is output from the indoor lamp switch 54b, the controller 36 lights or extinguishes the indoor lamp 53. When a signal for sounding the horn 56 is output from the horn switch 50a of the operation device 50, the controller 36 sounds the horn 56. When a signal for causing the hydraulic excavator 2 to travel by the lower traveling body 4 is output from the operation device 50, the controller 36 sounds the traveling alarm 58. When detecting abnormal states or the like of the apparatuses, the controller 36 sounds the buzzer 52c. Further, the controller 36 outputs a fuel amount and a urea water amount detected by the fuel-amount detecting means 28c and the urea-water-amount detecting means 32b to the display 52.

In the hydraulic excavator 2 configured as explained above, when the urea water is supplied to the urea water tank 32 and the urea-water-amount detecting means 32b detects that the urea water amount in the urea water tank 32 is increasing, the controller 36 flashes any one or a plurality of work lamps among the boom work lamp 22, the slewing-body work lamp 38, and the cab work lamps 46. A flashing interval of the work lamps is changed by the controller 36 according to the urea water amount in the urea water tank 32 to, for example, 1 Hz when the urea-water-amount detecting means 32b detects that the urea water amount in the urea water tank 32 exceeds 70% of the capacity of the urea water tank 32 and 2 Hz when it is detected that the urea water amount exceeds 80%. Consequently, the operator can recognize an approximate urea water amount in the urea water tank 32 when the operator is supplying the urea water to the urea water tank 32.

After flashing the work lamps, when the urea-water-amount detecting means 32b detects that the urea water amount in the urea water tank 32 exceeds a predetermined amount, for example, 90% of the capacity of the urea water tank 32, the controller 36 lights any one or a plurality of work lamps among the boom work lamp 22, the slewing-body work lamp 38, and the cab work lamps 46 or continuously or intermittently sound the horn 56. When any one of the work lamps is flashed, the work lamps lit by the controller 36 are the flashed lamp or/and the other work lamps. On the other hand, when the plurality of work lamps are flashed, the work lamps lit by the controller 36 are the flashed plurality of work lamps or/and the other work lamps.

The work lamps are lit or the horn 56 is sounded in this way, whereby the operator can easily confirm that the urea water amount in the urea water tank 32 exceeds the predetermined amount when the operator is supplying the urea water to the urea water tank 32. As a result, the operator does not allow the urea water to overflow from the urea water tank 32. When the urea-water-amount detecting means 32b detects that the urea water amount in the urea water tank 32 does not fluctuate for a predetermined time after exceeding the predetermined amount, the controller 36 extinguishes the work lamps. In the case where the horn 56 has been sounded, the controller 36 stops the sounding of the horn 56.

A second embodiment of the construction machine according to the present invention is explained. Note that, in the second embodiment, components same as the components in the first embodiment explained above are denoted by the same reference numerals and signs and explanation of the components is omitted.

When urea water is supplied to the urea water tank 32 and the urea-water-amount detecting means 32b detects that the urea water amount in the urea water tank 32 is increasing, the controller 36 intermittently sounds the horn 56. A sounding interval of the horn 56 is changed by the controller 36 according to the urea water amount in the urea water tank 32 to, for example, 1 Hz when the urea-water-amount detecting means 32b detects that the urea water amount in the urea water tank 32 exceeds 70% of the capacity of the urea water tank 32 and 2 Hz when it is detected that the urea water amount exceeds 80%. Consequently, an operator can recognize an approximate urea water amount in the urea water tank 32 when the operator is supplying the urea water to the urea water tank 32.

After intermittently sounding the horn 56, when the urea-water-amount detecting means 32b detects that the urea water amount in the urea water tank 32 exceeds a predetermined amount, for example, 90% of the capacity of the urea water tank 32, the controller 36 continuously sounds the horn 56 or lights or flashes any one or a plurality of work lamps among the boom work lamp 22, the slewing-body work lamp 38, and the cab work lamps 46. Consequently, the operator can easily confirm that the urea water amount in the urea water tank 32 exceeds the predetermined amount when the operator is supplying the urea water to the urea water tank 32. As a result, the operator does not allow the urea water to overflow from the urea water tank 32. When the urea-water-amount detecting means 32b detects that the urea water amount in the urea water tank 32 does not fluctuate for a predetermined time after exceeding the predetermined amount, the controller 36 stops the sounding of the horn 56 and, when the work lamps are lit or flashed, extinguishes the work lamps.

In the first and second embodiments, the warning means for issuing a warning to the operator, who supplies the urea water to the urea water tank 32, is constituted by the light emitting means such as the boom work lamp 22 that illuminates the periphery of the hydraulic excavator 2 or/and the horn 56 used, for example, when calling attention of the other operators present around the hydraulic excavator 2, for example, when the operator starts the engine 26. Therefore, exclusive warning means for issuing a warning is unnecessary. This is advantageous in terms of manufacturing costs and component management.

Note that the first and second embodiments explained above are illustrations of the present invention. The present invention is not limited to the embodiments. Various changes of the embodiments are possible. For example, the light emitting means functioning as the warning means is explained using the boom work lamp 22, the slewing-body work lamp 38, and the cab work lamps 46 as an example. However, the light emitting means may be any light emitting means as long as the operator supplying the urea water to the urea water tank 32 can recognize that the light emitting means is lit and flashing. The light emitting means may be, for example, the actuation indicator lamp 27b, the operation indicator lamp 47, or the indoor lamp 53 according to a disposition place of the urea water tank 32. The warning sound means functioning as the warning means is explained using the horn 56 as an example. However, the warning sound means any warning sound means as long as the operator supplying the urea water to the urea water tank 32 can recognize that the warning sound means is sounding. The warning sound means may be the buzzer 52c or the traveling alarm 58 according to a disposition place of the urea water tank 32. When the actuation indicator lamp 27b, the operation indicator lamp 47, or the indoor lamp 53 or the buzzer 52c or the traveling alarm 58 is used as the warning means, exclusive warning means is unnecessary as in the case where the work lamps or the horn is used as the warning means. This is advantageous in terms of manufacturing costs and component management. Light emitting means and warning sound means other than those explained above may be used as the warning means. Exclusive light emitting means or warning sound means for configuring the warning means may be disposed.

Concerning the start of the flashing of the light emitting means or the start of the intermittent sounding of the warning sound means, in the embodiments, the configuration is explained in which, when the urea-water-amount detecting means 32b detects that the urea water amount in the urea water tank 32 is increasing, the controller 36 starts the flashing of the light emitting means or starts the intermittent sounding of the warning sound means. However, a configuration may be adopted in which, when the operator supplies the urea water, the operator may manually operate, for example, the input means 52b of the display 52 or the switch disposed on the switch panel 54 to thereby start the flashing of the light emitting means or the intermittent sounding of the warning sound means. A configuration can be adopted in which, after the flashing of the light emitting means or the intermittent sounding of the warning sound means is started, the controller 36 changes the flashing interval of the light emitting means or the sounding interval of the warning sound means according to the urea water amount in the urea water tank 32 detected by the urea-water-amount detecting means 32b.

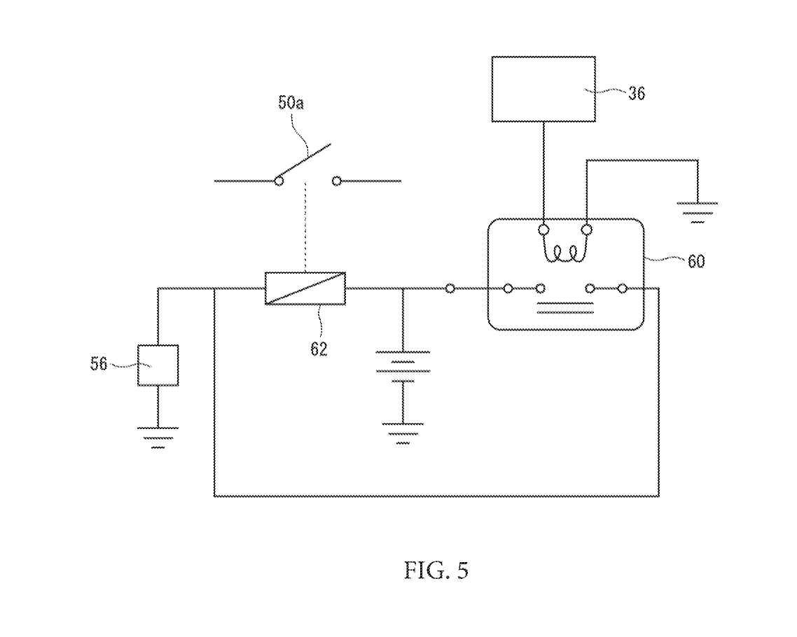

A configuration may be adopted in which, only when the urea-water-amount detecting means 32b detects that the urea water amount in the urea water tank 32 exceeds the predetermined amount, the controller 36 lights or flashes the light emitting means or intermittently or continuously sounds the warning sound means. The controller may consist of one controller or a plurality of controllers may be disposed in separate places and electrically connected to one another. The configuration is explained in which, when the signals for lighting or extinguishing the light emitting means such as the work lamps or for sounding the warning sound means such as the horn are output to the controller from the switches, the controller lights or extinguishes the light emitting means such as the work lamps, or sounds the warning sound means such as the horn. However, for example, as shown in FIG. 5, the switches does not have to be connected to the apparatuses via the controller as long as the horn 56 is connected to the controller 36 and the horn switch 50a respectively via relays 60 and 62.

1. A construction machine comprising: a urea water tank that stores urea water; detecting means for detecting a urea water amount in the urea water tank; warning means for issuing a warning to an operator who supplies the urea water to the urea water tank; and a controller connected to the detecting means and the warning means, wherein
the controller actuates the warning means when the detecting means detects that the urea water amount in the urea water tank exceeds a predetermined amount.

2. The construction machine according to claim 1, wherein the warning means is constituted by light emitting means.

3. The construction machine according to claim 2, wherein the controller lights the light emitting means when the detecting means detects that the urea water amount in the urea water tank exceeds the predetermined amount.

4. The construction machine according to claim 2, wherein the controller flashes the light emitting means when the detecting means detects that the urea water amount in the urea water tank is increasing.

5. The construction machine according to claim 1, wherein the warning means is constituted by warning sound means for emitting a warning sound.

6. The construction machine according to claim 5, wherein the controller continuously sounds the warning sound means when the detecting means detects that the urea water amount in the urea water tank exceeds the predetermined amount.

7. The construction machine according to claim 5, wherein the controller intermittently sounds the warning sound means when the detecting means detects that the urea water amount in the urea water tank is increasing.

8. The construction machine according to claim 1, wherein the warning means is constituted by light emitting means and warning sound means for emitting a warning sound.

9. The construction machine according to claim 8, wherein the controller flashes the light emitting means when the detecting means detects that the urea water amount in the urea water tank is increasing, and sounds the warning sound means when the detecting means detects that the urea water amount in the urea water tank exceeds the predetermined amount.

10. The construction machine according to claim 8, wherein the controller intermittently sounds the warning sound means when the detecting means detects that the urea water amount in the urea water tank is increasing, and lights or flashes the light emitting means when the detecting means detects that the urea water amount in the urea water tank exceeds the predetermined amount.

11. The construction machine according to claim 4, wherein the controller changes a flashing interval of the light emitting means according to the urea water amount in the urea water tank detected by the detecting means.

12. The construction machine according to claim 7, wherein the controller changes a sounding interval of the warning sound means according to the urea water amount in the urea water tank detected by the detecting means.

13. The construction machine according to claim 3, wherein the controller flashes the light emitting means when the detecting means detects that the urea water amount in the urea water tank is increasing.

14. The construction machine according to claim 13, wherein the controller changes a flashing interval of the light emitting means according to the urea water amount in the urea water tank detected by the detecting means.

15. The construction machine according to claim 6, wherein the controller intermittently sounds the warning sound means when the detecting means detects that the urea water amount in the urea water tank is increasing.

16. The construction machine according to claim 9, wherein the controller changes a flashing interval of the light emitting means according to the urea water amount in the urea water tank detected by the detecting means.

17. The construction machine according to claim 10, wherein the controller changes a sounding interval of the warning sound means according to the urea water amount in the urea water tank detected by the detecting means.
